(19) United States
(12) Patent Application Publication
(10) Pub. No.: US 2010/0276827 A1
(43) Pub. Date: Nov. 4, 2010

(54) Method for Producing Nanoparticles

(76) Inventors: Kevin Smith, Latrobe, PA (US); Joseph E. Wolfe, Richboro, PA (US)

Correspondence Address: Department of the Navy;(Naval Air Warfare Center -Aircraft Division), 47076 Lijencreantz Road, B 435, PATUXENT RIVER, MD, 20670, US

(21) Appl. No.: 12/432,019

(22) Filed: Apr. 29, 2009

(51) Int. Cl. B29B 9/00

(52) U.S. Cl. 264/12; 977/896; 977/773

(57) ABSTRACT

A method for producing nanoparticles which includes dissolving a solute into a solvent forming a solution, feeding the solution through a liquid entrance port of a convergent-divergent nozzle; feeding a carrier gas into a gas entrance port of the nozzle, mixing the solution and the carrier gas prior to entering the nozzle, upon exiting the nozzle the solution is atomized to micron sized droplets, and the evaporating the solvent and leaving behind solid state nanoparticles of the solute.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a method for producing or fabricating nanoparticles. More specifically, but without limitation, the present invention is a method for producing nanoparticles utilizing a converging-diverging nozzle.

Many studies have shown that materials that are nanoparticle in size have properties that differ from the material in bulk form. Nanoparticle technology is being utilized in combustion, chemical processing plants, coatings, composites as well as many other types of industries.

Current methods to produce nanoparticles typically utilize highly complex processes or equipment, and techniques, which were developed for a specialized specific material or product. Examples, but without limitation, include high electrical pulsed plasma and arc discharge techniques, flame spraying pyrolysis, steps involving wet chemistry type processes and utilization of a flame with an electric arc discharge.

For the foregoing reasons, there is a need for a method for producing nanoparticles.

### SUMMARY

The present invention is directed to a method for producing nanoparticles that meets the needs enumerated above and below.

The present invention is directed to a method for producing nanoparticles which includes dissolving a solute into a solvent such that a solution is formed, feeding the solution through a liquid entrance port of a convergent-divergent nozzle, feeding a carrier gas into a gas entrance port of the nozzle, mixing the solution and the carrier gas prior to entering the nozzle, upon exiting the nozzle the solution is atomized to micron sized droplets, and evaporating the solvent from the solution and leaving behind solid state nanoparticles of the solute.

It is a feature of the present invention to provide a method for producing nanoparticles that utilizes a simple process that can be utilized for a variety of substances to produce nanoparticles.

It is a feature of the present invention to provide a method for producing nanoparticles from micron size droplets of a liquid by rapid removal of the droplet solvent, leaving behind solute nanoparticles material.

It is a feature of the present invention to provide a method for producing nanoparticles that can control the size of the nanoparticles by the concentration of the solution fed into the nozzle.

Additionally, the nozzle size, the flow rates of the carrier gas, and the solution and the temperature can be changed such that the size of the nanoparticles are different.

### DRAWINGS

These and other features, aspects and advantages of the present invention will become better understood with reference to the following description and appended claims, and accompanying drawings wherein:

FIG. 1 is an embodiment of the method for producing nanoparticles;

FIG. 2 is another embodiment of the method for producing nanoparticles; and

FIG. 3 is substrate material being coated using the method for producing nanoparticles.

### DESCRIPTION

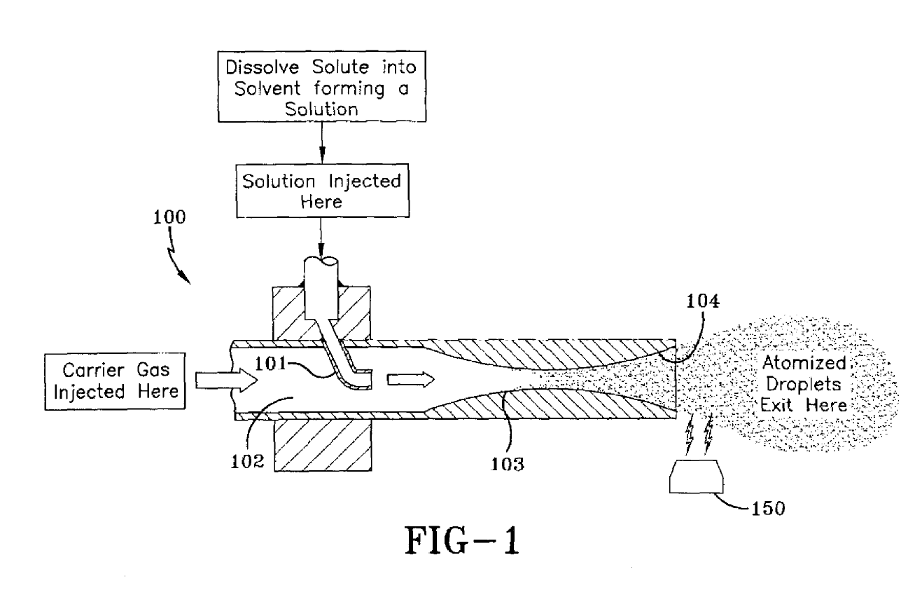

The preferred embodiments of the present invention are illustrated by way of example below and in FIGS. 1-3. As shown in FIG. 1, the method for producing nanoparticles includes dissolving a solute into a solvent forming a solution, feeding the solution through a liquid entrance port 101 of a convergent-divergent nozzle 100; feeding a carrier gas into a gas entrance port 102 of the nozzle 100, mixing the solution and the carrier gas prior to entering the nozzle 100 (particularly prior to the throat region 103 of the nozzle 100), upon exiting the nozzle 100 the solution is atomized to micron sized droplets, and evaporating (or burning off) the solvent and non-nanoparticle portion of the solute leaving behind solid state nanoparticles of the solute.

The preferred nozzle is a convergent-divergent nozzle as described in U.S. Pat. No. 5,520,331 to Joseph Wolfe, assigned to the United States of America, as represented by the Secretary of the Navy. U.S. Pat. No. 5,520,331 is hereby incorporated by reference. The nozzle was designed to atomize water to very fine droplets with forward momentum for use in extinguishing fires. To atomize a liquid, the liquid is injected from a side port (a liquid entrance port 101) into the middle of a gas stream (a carrier gas) that is directed from a gas port or tube (gas entrance port 102), pushing and compressing the liquid/gas mixture into the throat region 103 of the nozzle 100. The mixture exits the throat region 103 into the divergent end 104 of the nozzle 100, where the rapid expansion of the liquid/gas causes the liquid to atomize Utilizing a dissolved solid material as the liquid, the result is micron size droplets of the dissolved solid material.

A solute or solute material must first be dissolved in a solvent. The solute may be a solid or liquid material and, without limitation, selected from the group of organometallics, metalorganics, chelated compounds, bioorganometallics, organic coordination compounds and/or complex type compounds that contain the various groups of elements from the periodic table such as, but without limitation, Alkali metals (Li, Na, K, etc), Alkaline metals (Be, Mg, Ba, etc), Transition metals (Fe, Co, Ni, Ti, Pt, Y, etc.), Post-transition metals (Al, Ga, In, Sn, etc), Lanthanides, Actinides, and Metalloids or Semimetals (B, Si, Ge, As, Sb, etc.). A few representative compounds of solute that can be used include, but are not limited to, lithium dimethylcuprate, butyllithium, diethylmagnesium, chloro(ethoxycarbonylmethyl)zinc, metal acetylacetonates (metal can be Cr, Cu, Mn, Ni, V, Al, etc.), dibenzenechromium, ferrocene, dimethyl titanocene, Isobutylgermane triethylborane, Grignard reagents, iron porphyrins, cisplatin, Chlorophyll, and metal-containing proteins. The solvent used can be a non combustible liquid such as water, or a combustible liquid such as any organic liquid such as any type of alcohol (such as, but without limitation, methanol, ethanol, propanol, isopropyl alcohol), esters, hydrocarbons, aromatics, ketones or aldehydes.

The carrier gas may be any type of gas that can be mixed with a liquid. The preferred carrier gas can be, but without limitation, any or a combination of the following gases: air, oxygen, nitrogen, argon, helium, methane, ethane, propane, natural gas, hydrogen, acetylene, aldehydes and the like. The specific gas or mixture of gases will be based on whether the nanoparticle creation environment is either oxidizing, reducing or neutral. An oxidizing environment would be appropriate for the creation of oxide based nanoparticles, while a reducing environment would be suitable for the creation of metal, elemental and non-oxide based nanoparticles. In a reducing environment, the preferred carrier gas is hydrogen; however, any other gases used in oxygen poor states, such as carbon monoxide, could be suitable. The carrier gas may be consumed in a flash off process (if it is combustible) or if the carrier gas is an inert gas (such as, but without limitation, argon, helium or nitrogen) the carrier gas would dissipate and carry and provide momentum for gas suspended nanoparticles.

The concentration or the amount of solute that is dissolved in the solvent dictates the amount of material available in each droplet that would form a nanoparticle. Thus, the design and general arrangement allows for the size of the nanoparticles to be adjusted by changing the concentration of the soluble nanoparticle material that is dissolved in the solvent.

The evaporation of the solvent may be enhanced by passing the atomized droplets through a heat source. The heat source can be a flame, a high temperature furnace, electric arc or plasma, resistive heating wires or rods, burners, laser beams, microwaves or any type of heat source practicable. A vacuum system could also be utilized, similar to what is utilized in freeze drying techniques. The particle size and properties can be adjusted by changing the temperature of the heat source and/or changing the temperature of the surface the nanoparticles are being applied to.

In one of the embodiments of the invention, the solvent may be flashed off by a sudden luminous temporary flame or burner or a gas igniter 150 as shown in FIG. 1, and/or by using a combustible carrier gas and/or a combustible solvent or a plasma. In some cases, all of the solute may not have enough time to nucleate into a single particle, resulting in creating numerous individual particles from each droplet, resulting in smaller and a larger number of nanoparticles. It is possible that if the solvent is flashed off by using a combustible carrier gas and/or solvent, all of the solute in a droplet may not have enough time to nucleate into a single particle, resulting in the creation of numerous individual particles from each droplet. Therefore using a combustible mixture that is ignited at the nozzle tip should create smaller and a larger number of nanoparticles.

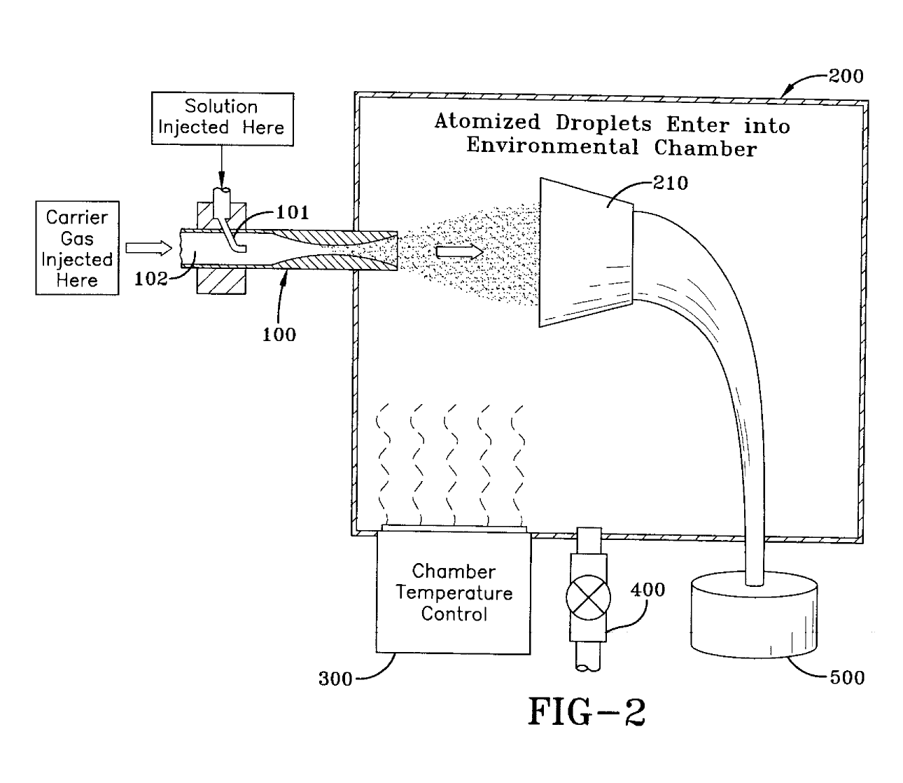

In another embodiment of the invention, as shown in FIG. 2, the atomized droplets are passed through an environmentally controlled chamber 200 that enhances the evaporation of the solvent. Heat and/or a vacuum may be applied to the chamber to enhance the evaporation process. As shown in FIG. 2, heat may be applied via a chamber temperature control unit 300, and a vacuum may be applied via an exhaust or vacuum port 400. The droplets and/or particles may be collected in a particle collector 500 via a particle collection funnel 210 disposed within the environmentally controlled chamber 200, and then applied to a desired area. A reactant gas or vapor that reacts with the droplets and or particles created by the nozzle may be added to the chamber 200. Any combination described herein may be utilized.

Evaporation of the solvent can be enhanced by immediately passing the stream of atomized droplets through a high temperature furnace, enabling the vaporization of solvent. The temperature of the furnace can be varied to obtain the desired properties and particle size of the nanoparticle product.

The flash temperature at the nozzle tip will dictate the rate of evaporation of solvent, which in turn should dictate the size and number of particles created. The flash temperature can be controlled by a number of parameters such as the ratio of combustible to oxygen/oxidizer mixture at the nozzle tip, the type of carrier gas or carrier gas mixture utilized (such as singularly or mixtures of the following gases: air, hydrogen, acetylene, propane, oxygen, etc.), the flow rate of the combustible mixture, and the ratio of the flow rate of the carrier gas and liquid solution.

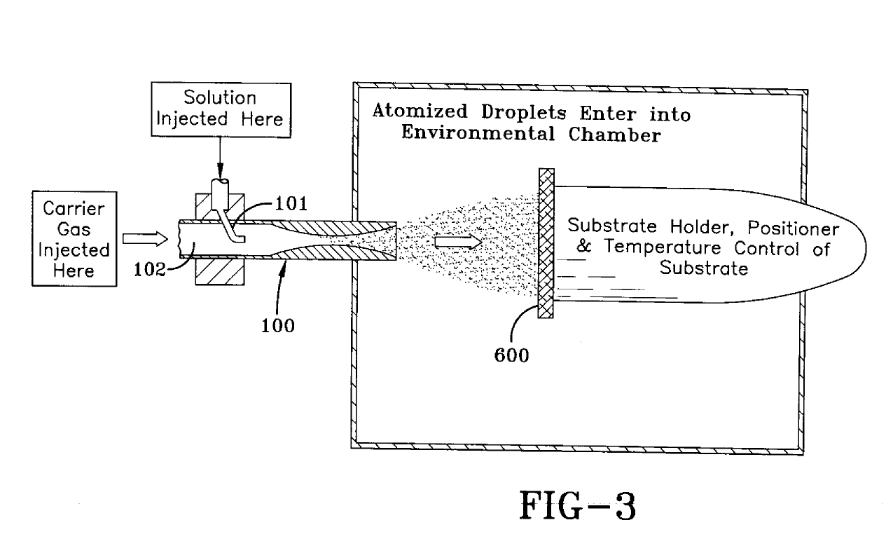

As shown in FIG. 3, the droplets exiting the nozzle 100 may be aimed at a desired target, such as, but without limitation, a substrate material 600. The substrate material 600 may be temperature controlled. The substrate material 600 may be heated to high temperatures to facilitate evaporation of solvent, creation of a solid state phase of particles, and/or enhancement of particle adhesion to the substrate material 600. The substrate material 600 may also be cooled to condense particle stream. The droplets may impinge onto a hot surface. The particle size and properties can be varied by changing the temperature of the surface. In one of the embodiments of the invention, the target substrate or nozzle can be methodically moved to continually expose new substrate surfaces to the impinging droplets and/or nanoparticles, thus controlling rates of deposition, nanoparticle sizes, amount of agglomerates formed, etc. A spinning cylinder or wheel temperature controlled substrate in which nanoparticles are continuously scrapped off and collected could be a method for the continous production of nanoparticles.

The size of the nanoparticles may be controlled by the concentration of the solution that is fed into the nozzle. The concentration or the amount of solute that is dissolved in the solvent dictates the amount of material available in each droplet that would form into a nanoparticle. Therefore the size of nanoparticles produced can be adjusted by changing the concentration of the solute nanoparticle material that is dissolved in the solvent.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for producing nanoparticles, comprising:
dissolving a solute into a solvent such that a solution is formed;
feeding the solution through a liquid entrance port of a convergent-divergent nozzle;
feeding a carrier gas into a gas entrance port of the nozzle;
mixing the solution and the carrier gas prior to entering the nozzle, upon exiting the nozzle the solution is atomized to micron sized droplets; and
evaporating the solvent and non-nanoparticle portion of the solute from the solution leaving behind solid state nanoparticles of the solute.

2. The method of claim 1, wherein the method further includes igniting the solvent upon exiting the nozzle such that the solvent is flashed off and the remaining solute is annealed.

3. The method of claim 1, wherein the method further includes passing the atomized droplets from the nozzle through an environmentally controlled chamber that enhances the evaporation of the solvent.

4. The method of claim 3, wherein a vacuum is applied to the chamber to enhance the evaporation process.

5. The method of claim 3, wherein heat is applied to the chamber to enhance the evaporation process.

6. The method of claim 3, wherein heat and vacuum are applied to the chamber to enhance the evaporation process.

7. The method of claim 3, where a reactant gas or vapor is added to the chamber that reacts with the droplets and or particles created by the nozzle.

8. The method of claim 1, where the gas droplets created by nozzle are aimed at a desired substrate material.

9. The method of claim 8, wherein substrate material is temperature controlled.

10. The method of claim 9, wherein the substrate is heated to high temperatures to facilitate evaporation of solvent, creation of a solid state phase of particles, and/or enhancement of particle adhesion to the substrate.

11. The method of claim 9 wherein the substrate is cooled to condense particle stream.

12. The method of claim 1 wherein the solvent is be flashed off by a sudden luminous temporary flame.

13. The method of claim 1 wherein the carrier gas is a flammable gas.

14. A method for producing nanoparticles, comprising:
dissolving a solute into a solvent forming a solution, wherein the solute is a material selected from the group consisting of organometallics, metalorganics, chelated compounds, bioorganometallics, organic coordination compounds, and complex type compounds that contain the various groups of metals from the periodic table;
feeding the solution through a liquid entrance port of a convergent-divergent nozzle;
feeding a carrier gas into a gas entrance port of the nozzle;
mixing the solution and the carrier gas prior to entering the nozzle, upon exiting the nozzle the second solution is atomized to micron sized droplets; and
evaporating the solvent from the solution and leaving behind solid state nanoparticles of the solute.

15. The method of claim 14, wherein the carrier gas is a combination of the following gases:
methane, ethane, propane, natural gas, hydrogen, acetylene, and aldehydes.

16. The method of claim 15, wherein the solvent is be flashed off by a gas igniter.

17. The method of claim 16, wherein the carrier gas is a flammable gas.
